(19) United States
(12) Patent Application Publication
(10) Pub. No.: US 2025/0074417 A1
(43) Pub. Date: Mar. 6, 2025

(54) VEHICLE CONTROLLER, METHOD, AND COMPUTER PROGRAM FOR VEHICLE CONTROL

(71) Applicant: Toyota Jidosha Kabushiki Kaisha, Toyota-shi Aichen-ken (JP)

(72) Inventor: Kenta Kumazaki, Endogawa-ku Tokyo-to (JP)

(73) Assignee: Toyota Jidosha Kabushiki Kaisha, Toyota-shi Aichen-ken (JP)

(21) Appl. No.: 18/595,692

(22) Filed: Mar. 5, 2024

(30) Foreign Application Priority Data
Mar. 7, 2023 (JP) 2023-034816

(51) Int. Cl. B60W 30/18; B60W 50/14; B60W 60/00

(52) U.S. Cl. CPC B60W 30/18009; B60W 50/14; B60W 60/0025; B60W 2530/10; B60W 2552/53

(57) ABSTRACT

A vehicle controller includes a processor configured to: detect that a host vehicle under autonomous driving control is towing a towed vehicle, determine whether an involvement requirement for requesting a driver of the host vehicle to be involved in driving the host vehicle 10 is satisfied, give notification of the request for involvement in driving via a notification device provided in the vehicle interior, when the involvement requirement is satisfied, and make the involvement requirement less strict when towing the towed vehicle by the host vehicle is detected than when towing the towed vehicle by the host vehicle is not detected.

### CROSS-REFERENCE TO RELATED APPLICATIONS

This application claims priority to Japanese Patent Application No. 2023-034816 filed Mar. 7, 2023, the entire contents of which are herein incorporated by reference.

### FIELD

The present disclosure relates to a vehicle controller, a method, and a computer program for vehicle control.

### BACKGROUND

Motion of a vehicle towing another vehicle sometimes differs from motion of a vehicle that is not towing another vehicle. In autonomous driving control of a vehicle towing another vehicle, it is therefore desirable to control the towing vehicle, taking account of the difference in motion of the towing vehicle with and without a towed vehicle. In view of this, a technique has been proposed to control a vehicle differently depending on whether a towed vehicle is coupled (see Japanese Patent JP6951262B).

A driving support device disclosed in JP6951262B sets driving mode to restricted second driving support mode when coupling of a towed vehicle is detected. The restricted second driving support mode in which autonomous driving is executed without a steering wheel being gripped, is applied only when travel on the same lane continues. At a lane change, the driving support device changes driving mode to first driving support mode, in which autonomous driving is executed only when a steering wheel is gripped.

### SUMMARY

When autonomous driving control is applied to a vehicle towing a towed vehicle, an increase in the degree of a driver's involvement in driving may be required in some cases. In such cases, it is desirable that timing for increasing the degree of the driver's involvement in driving can be set appropriately.

It is an object of the present disclosure to provide a vehicle controller that can appropriately set timing for increasing the degree of involvement in driving of a driver of a vehicle towing a towed vehicle and being under autonomous driving control.

According to an embodiment, a vehicle controller is provided. The vehicle controller includes a processor configure to: detect that a host vehicle under autonomous driving control is towing a towed vehicle, determine whether an involvement requirement for requesting a driver of the host vehicle to be involved in driving the host vehicle is satisfied, based on an exterior sensor signal generated by an exterior sensor configured to detect conditions around the host vehicle, an interior sensor signal generated by an interior sensor configured to detect conditions in an interior of the host vehicle, a vehicle motion signal generated by a motion sensor configured to detect motion of the host vehicle, or the position of the host vehicle, give notification of the request for involvement in driving via a notification device provided in the interior of the host vehicle, when the involvement requirement is satisfied, and make the involvement requirement less strict when towing the towed vehicle by the host vehicle is detected than when towing the towed vehicle by the host vehicle is not detected.

The processor of the vehicle controller measures a lateral distance between a lane line demarcating a lane being traveled by the host vehicle and the host vehicle, based on the exterior sensor signal, and determines that the involvement requirement is satisfied, when the lateral distance falls below a predetermined distance threshold; and makes the distance threshold greater when towing the towed vehicle by the host vehicle is detected than when towing the towed vehicle by the host vehicle is not detected.

In this case, the processor increases the distance threshold for the case where towing the towed vehicle by the host vehicle is detected, as weight or volume of the towed vehicle increases.

The processor determines that the involvement requirement is satisfied, when the speed of the host vehicle indicated by the vehicle motion signal is greater than a regulation speed of a road being traveled by the host vehicle by more than a predetermined speed threshold; and sets the speed threshold to a lower value when towing the towed vehicle by the host vehicle is detected than when towing the towed vehicle by the host vehicle is not detected.

The processor determines that the involvement requirement is satisfied, when a regulation speed of a road being traveled by the host vehicle is less than a predetermined speed; and sets the predetermined speed to a higher value when towing the towed vehicle by the host vehicle is detected than when towing the towed vehicle by the host vehicle is not detected.

The processor determines that the involvement requirement is satisfied, when the radius of curvature of a curve in a section being traveled by the host vehicle or extending to a predetermined distance away is less than a predetermined curvature radius threshold; and sets the curvature radius threshold to a higher value when towing the towed vehicle by the host vehicle is detected than when towing the towed vehicle by the host vehicle is not detected.

The processor determines that the involvement requirement is satisfied, when the gradient of a road in a section being traveled by the host vehicle or extending to a predetermined distance away is not less than a predetermined gradient threshold; and sets the gradient threshold to a lower value when towing the towed vehicle by the host vehicle is detected than when towing the towed vehicle by the host vehicle is not detected.

According to another embodiment, a vehicle controller is provided. The vehicle controller includes a processor configured to: detect that a host vehicle under autonomous driving control is towing a towed vehicle, detect a relative position and a relative speed between the host vehicle and another vehicle traveling on an adjacent lane adjacent to a host vehicle lane being traveled by the host vehicle, execute lane change control of the host vehicle, when a predetermined condition is satisfied, so that the host vehicle makes a lane change from the host vehicle lane to the adjacent lane, determine whether an interruption condition that is set based on at least one of the relative speed or a change in the relative position is satisfied during execution of the lane change control, interrupt the lane change control when the interruption condition is satisfied, and make the interruption condition less strict when towing the towed vehicle by the host vehicle is detected than when towing the towed vehicle by the host vehicle is not detected.

According to still another embodiment, a method for vehicle control is provided. The method includes detecting that a host vehicle under autonomous driving control is towing a towed vehicle; determining whether an involvement requirement for requesting a driver of the host vehicle to be involved in driving the host vehicle is satisfied, based on an exterior sensor signal generated by an exterior sensor configured to detect conditions around the host vehicle, an interior sensor signal generated by an interior sensor configured to detect conditions in an interior of the host vehicle, a vehicle motion signal generated by a motion sensor configured to detect motion of the host vehicle, or the position of the host vehicle; giving notification of the request for involvement in driving via a notification device provided in the interior of the host vehicle, when the involvement requirement is satisfied; and making the involvement requirement less strict when towing the towed vehicle by the host vehicle is detected than when towing the towed vehicle by the host vehicle is not detected.

According to yet another embodiment, a non-transitory recording medium that stores a computer program for vehicle control is provided. The computer program includes instructions causing a processor mounted on a host vehicle to execute a process including detecting that the host vehicle under autonomous driving control is towing a towed vehicle; determining whether an involvement requirement for requesting a driver of the host vehicle to be involved in driving the host vehicle is satisfied, based on an exterior sensor signal generated by an exterior sensor configured to detect conditions around the host vehicle, an interior sensor signal generated by an interior sensor configured to detect conditions in an interior of the host vehicle, a vehicle motion signal generated by a motion sensor configured to detect motion of the host vehicle, or the position of the host vehicle; giving notification of the request for involvement in driving via a notification device provided in the interior of the host vehicle, when the involvement requirement is satisfied; and making the involvement requirement less strict when towing the towed vehicle by the host vehicle is detected than when towing the towed vehicle by the host vehicle is not detected.

The vehicle controller according to the present disclosure has an effect of being able to appropriately set timing for increasing the degree of involvement in driving of a driver of a vehicle towing a towed vehicle and being under autonomous driving control.

### BRIEF DESCRIPTION OF DRAWINGS

FIG. 1 schematically illustrates the configuration of a vehicle control system equipped with a vehicle controller.

FIG. 2 illustrates the hardware configuration of an electronic control unit, which is an embodiment of the vehicle controller.

FIG. 3 is a functional block diagram of a processor of the electronic control unit, related to a vehicle control process according to a first embodiment.

FIG. 4A illustrates an example of the relationship between a hands-on request threshold for the case where towing a towed vehicle is not detected and a hands-on request threshold for the case where towing a towed vehicle is detected.

FIG. 4B illustrates an example of the relationship between a hands-on request threshold for the case where towing a towed vehicle is not detected and a hands-on request threshold for the case where towing a towed vehicle is detected.

FIG. 5A illustrates an example of the relationship between a transition demand threshold for the case where towing a towed vehicle is not detected and a transition demand threshold for the case where towing a towed vehicle is detected.

FIG. 5B illustrates an example of the relationship between a transition demand threshold for the case where towing a towed vehicle is not detected and a transition demand threshold for the case where towing a towed vehicle is detected.

FIG. 6 is an operation flowchart of the vehicle control process related to a change of the degree of the driver's involvement in driving according to the first embodiment.

FIG. 7 is a functional block diagram of the processor of the electronic control unit, related to a vehicle control process according to a second embodiment.

FIG. 8 illustrates the relationship between whether towing a towed vehicle is detected and a time threshold, which is an example of the interruption condition.

FIG. 9 is an operation flowchart of the vehicle control process related to a lane change according to the second embodiment.

### DESCRIPTION OF EMBODIMENTS

A vehicle controller, a method for vehicle control executed by the vehicle controller, and a computer program for vehicle control will now be described with reference to the attached drawings. The vehicle controller executes autonomous driving control of travel of a host vehicle capable of towing a towed vehicle. More specifically, the vehicle controller determines whether an involvement requirement for requesting a driver of the host vehicle to be involved in driving the host vehicle is satisfied, and gives notification of a request for involvement in driving via a notification device provided in the vehicle interior, when it is determined that the involvement requirement is satisfied. The vehicle controller makes the involvement requirement less strict when towing the towed vehicle by the host vehicle is detected than when towing the towed vehicle by the host vehicle is not detected.

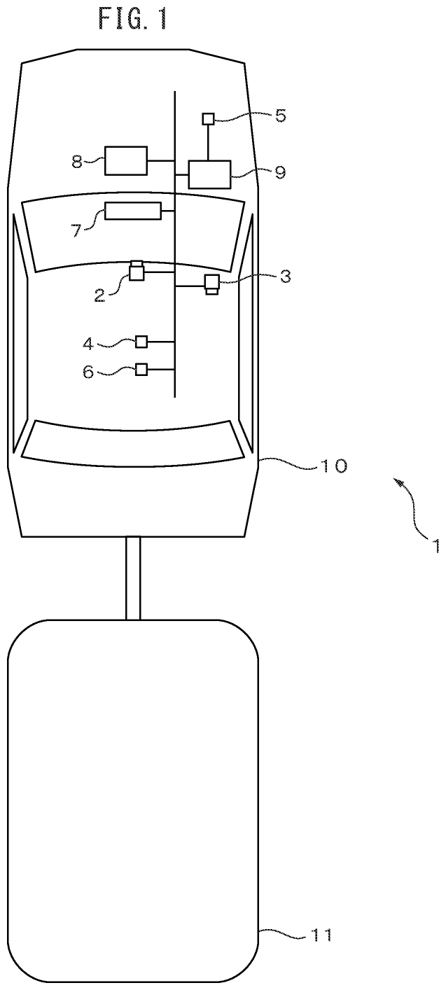

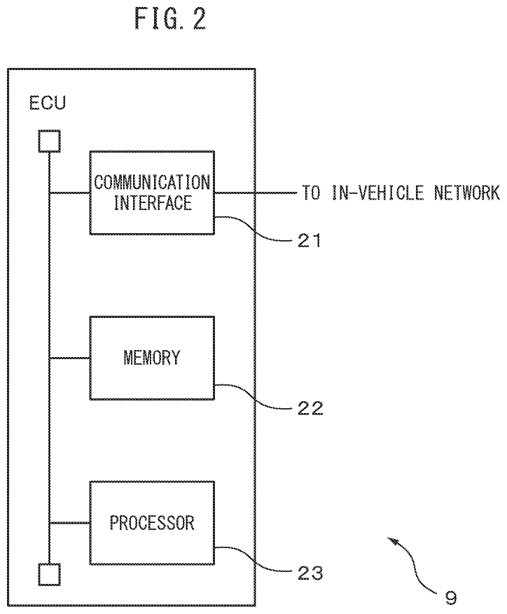

FIG. 1 schematically illustrates the configuration of a vehicle control system equipped with the vehicle controller. FIG. 2 illustrates the hardware configuration of an electronic control unit, which is an embodiment of the vehicle controller. In the present embodiment, a vehicle control system 1, which is mounted on a host vehicle 10 and controls the vehicle 10, includes a camera 2, a driver monitoring camera 3, a GPS receiver 4, a motion sensor 5, a wireless communication terminal 6, a notification device 7, a storage device 8, and an electronic control unit (ECU) 9, which is an example of the vehicle controller. The camera 2, the driver monitoring camera 3, the GPS receiver 4, the wireless communication terminal 6, the notification device 7, and the storage device 8 are communicably connected to the ECU 9 via an in-vehicle network conforming to a standard such as a controller area network. The motion sensor 5 is also communicably connected to the ECU 9. The vehicle control system 1 may further include a range sensor (not illustrated) that measures the distances from the vehicle 10 to objects around the vehicle 10, such as LiDAR or radar. The vehicle control system 1 may further include a navigation device (not illustrated) for searching for a route to a destination.

The vehicle 10 further includes equipment for towing a towed vehicle 11, such as a tow hook, and is thereby capable of towing the towed vehicle 11.

The camera 2, which is an example of the exterior sensor, includes a two-dimensional detector constructed from an array of optoelectronic transducers, such as CCD or C-MOS, having sensitivity to visible light and a focusing optical system that forms an image of a target region on the two-dimensional detector. The camera 2 is mounted, for example, in the interior of the vehicle 10 so as to be oriented, for example, to the front of the vehicle 10. The camera 2 takes a picture of a region in front of the vehicle 10 every predetermined capturing period (e.g., 1/30 to 1/10 seconds), and generates images representing the region. Each image obtained by the camera 2 is an example of an exterior sensor signal representing conditions around the vehicle 10. The vehicle 10 may include multiple cameras taking pictures in different orientations or having different focal lengths.

Every time an image is generated, the camera 2 outputs the generated image to the ECU 9 via the in-vehicle network.

The driver monitoring camera 3, which is an example of the interior sensor, includes a two-dimensional detector constructed from an array of optoelectronic transducers, such as CCD or C-MOS, having sensitivity to visible or infrared light and a focusing optical system that forms an image of a target region on the two-dimensional detector, similarly to the camera 2. The driver monitoring camera 3 may further include a light source, such as an infrared LED, for illuminating the driver. The driver monitoring camera 3 is mounted, for example, on or near an instrument panel and oriented to the driver so that the head of the driver sitting on the driver's seat of the vehicle 10 may be included in the target region, i.e., so that pictures of the driver's head can be taken. The driver monitoring camera 3 takes pictures of the driver every predetermined capturing period (e.g., 1/30 to 1/10 seconds), and generates images representing the driver (hereafter “driver images”). Each driver image obtained by the driver monitoring camera 3 is an example of an interior sensor signal representing conditions in the interior of the vehicle 10, and may be a color or grayscale image. Every time a driver image is generated, the driver monitoring camera 3 outputs the generated driver image to the ECU 9 via the in-vehicle network.

The GPS receiver 4 receives GPS signals from GPS satellites at predetermined intervals, and determines the position of the vehicle 10, based on the received GPS signals. The GPS receiver 4 outputs positioning information indicating the result of determination of the position of the vehicle 10 based on the GPS signals to the ECU 9 via the in-vehicle network at predetermined intervals. Instead of the GPS receiver, the vehicle 10 may include a receiver that receives positioning signals from satellites of another satellite positioning system to determine the position of the vehicle 10.

The motion sensor 5 is a sensor for sensing motion of the vehicle 10, and includes, at least, a torque sensor that detects torque applied to a drive shaft of driving wheels, and an acceleration sensor that detects the acceleration of the vehicle 10. The vehicle control system 1 may include different types of motion sensors 5. For example, the motion sensor 5 may include a speed sensor or a gyro sensor. Every time a sensor signal indicating motion of the vehicle 10 is generated, the motion sensor 5 outputs the generated sensor signal to the ECU 9. A sensor signal generated by the motion sensor 5 (e.g., a torque-indicating signal generated by the torque sensor, an acceleration/deceleration-indicating signal generated by the acceleration sensor, or a speed-indicating signal generated by the speed sensor) is an example of a vehicle motion signal indicating motion of the vehicle 10.

The wireless communication terminal 6 communicates with a wireless base station by wireless in conformity with a predetermined standard of mobile communications. The wireless communication terminal 6 receives map information including a high-precision map used for autonomous driving control from a map server via the wireless base station, and outputs the received map information to the storage device 8 via the in-vehicle network.

The notification device 7 is provided in the interior of the vehicle 10, and gives predetermined notification to the driver by light, voice, vibration, or display of text or an image. To achieve this, the notification device 7 includes, for example, at least one of a speaker, a light source, a vibrator, or a display. When a notification signal indicating predetermined notification to the driver (e.g., a hands-on request or a transition demand) is received from the ECU 9, the notification device 7 gives the notification to the driver by a voice from the speaker, lighting up or blinking of the light source, vibration of the vibrator, or displaying a message on the display. When the notification device 7 includes two or more types of devices, the notification may be given to the driver via each of the two or more types of devices.

The storage device 8, which is an example of a storage unit, includes, for example, a hard disk drive, a nonvolatile semiconductor memory, or an optical medium and an access device therefor. The storage device 8 stores a high-precision map.

The storage device 8 further includes a processor for executing, for example, a process to update map information and a process related to a request from the ECU 9 to read out the high-precision map. For example, every time the vehicle 10 moves a predetermined distance, the storage device 8 transmits a request to obtain map information, together with the current position of the vehicle 10, to the map server via the wireless communication terminal 6. The storage device 8 receives map information including a high-precision map of a predetermined region around the current position of the vehicle 10 from the map server via the wireless communication terminal 6, and stores the high-precision map included in the received map information. In addition, when a request from the ECU 9 to read out a map is received, the storage device 8 cuts out that portion of the high-precision map stored therein which includes the current position of the vehicle 10 and which represents a region smaller than the predetermined region, and outputs the cutout portion to the ECU 9 via the in-vehicle network. The high-precision map includes information used for autonomous driving control of the vehicle 10, such as the number of lanes of each road section, the width of each lane, regulation speeds, road markings including lane lines, and various traffic signs.

The ECU 9 executes autonomous driving control of the vehicle 10. In addition, while executing autonomous driving control of the vehicle 10, the ECU 9 determines whether an involvement requirement for requesting involvement in driving the vehicle is satisfied. When the involvement requirement is satisfied, the ECU 9 requests the driver to be involved in driving, via the notification device 7.

Examples of the request for involvement in driving include a request for holding the steering wheel (hands-on request) and a request for transferring control to the driver (transition demand).

As illustrated in FIG. 2, the ECU 9 includes a communication interface 21, a memory 22, and a processor 23. The communication interface 21, the memory 22, and the processor 23 may be configured as separate circuits or a single integrated circuit.

The communication interface 21 includes an interface circuit for connecting the ECU 9 to another device. Every time an image is received from the camera 2, the communication interface 21 passes the received image to the processor 23. Every time a driver image is received from the driver monitoring camera 3, the communication interface 21 passes the received driver image to the processor 23. Every time positioning information is received from the GPS receiver 4, the communication interface 21 passes the positioning information to the processor 23. Every time a sensor signal is received from the motion sensor 5, the communication interface 21 passes the sensor signal to the processor 23. Further, the communication interface 21 passes a high-precision map read from the storage device 8 to the processor 23, and outputs a notification signal received from the processor 23 to the notification device 7.

The memory 22, which is another example of a storage unit, includes, for example, volatile and nonvolatile semiconductor memories, and stores various types of data used in a vehicle control process executed by the processor 23. For example, the memory 22 stores images of the surroundings of the vehicle 10 received from the camera 2, driver images received from the driver monitoring camera 3, positioning information of the vehicle 10 received from the GPS receiver 4, measured values indicating motion of the vehicle 10 in sensor signals received from the motion sensor 5, and a high-precision map read from the storage device 8. In addition, the memory 22 stores parameters of the camera 2, such as the focal length, the orientation, and the mounted position, as well as various parameters for specifying a classifier for object detection used for detecting features and other objects. Further, the memory 22 temporarily stores various types of data generated during the vehicle control process.

The processor 23 includes one or more central processing units (CPUs) and a peripheral circuit thereof. The processor 23 may further include another operating circuit, such as a logic-arithmetic unit, an arithmetic unit, or a graphics processing unit. The processor 23 executes the vehicle control process on the vehicle 10 at predetermined intervals. In addition, the processor 23 changes an involvement requirement for determining whether to request the driver to increase the degree of involvement in driving, depending on whether the vehicle 10 is towing a towed vehicle. The processor 23 further changes an interruption condition for determining whether to interrupt a lane change process on the vehicle 10, depending on whether the vehicle 10 is towing a towed vehicle, after the start of the lane change process.

### First Embodiment

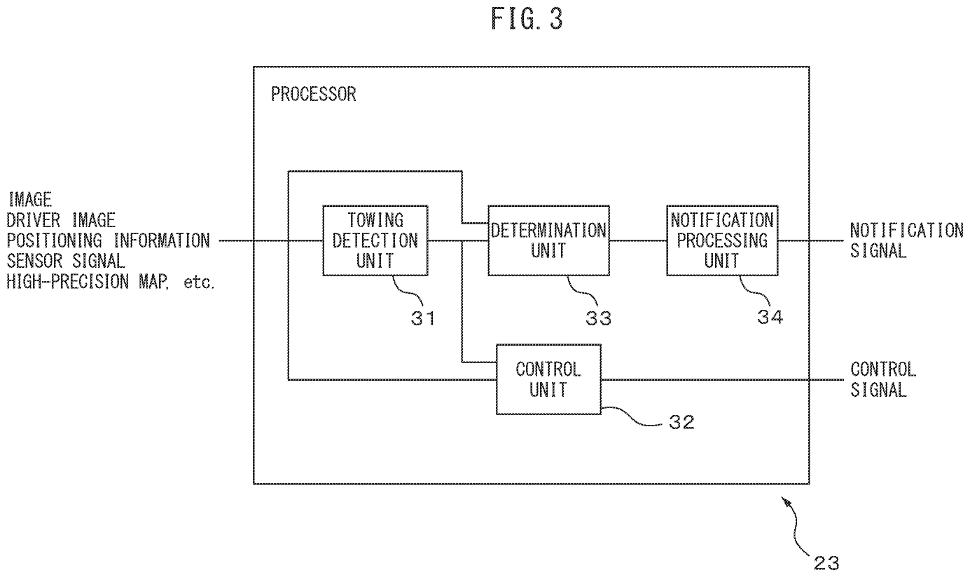

FIG. 3 is a functional block diagram of the processor 23, related to the vehicle control process according to a first embodiment. The processor 23 includes a towing detection unit 31, a control unit 32, a determination unit 33, and a notification processing unit 34. These units included in the processor 23 are functional modules, for example, implemented by a computer program executed by the processor 23, or may be dedicated operating circuits provided in the processor 23.

In the first embodiment, the processor 23 determines whether an involvement requirement is satisfied, during execution of autonomous driving control of the vehicle 10, and notifies the driver of a request for involvement in driving the vehicle 10, via notification device 7, when the involvement requirement is satisfied. The processor 23 changes the involvement requirement, depending on whether towing a towed vehicle 11 by the vehicle 10 is detected. In the following, towing a towed vehicle 11 by the vehicle 10 will be referred to simply as a “towing a towed vehicle 11.”

The towing detection unit 31 detects that the vehicle 10 is towing a towed vehicle 11. Whether the vehicle 10 is towing a towed vehicle 11 is expected to remain unchanged during driving of the vehicle 10. Thus, once determination is made regarding detection of towing a towed vehicle 11, the towing detection unit 31 may omit to make the determination until an ignition switch of the vehicle 10 is turned off.

For example, the towing detection unit 31 uses those sensor signals indicating measured values of acceleration and torque at acceleration of the vehicle 10, which are obtained from the motion sensor 5 when the vehicle 10 is in a predetermined state, for detection of towing a towed vehicle 11. The towing detection unit 31 compares the acceleration with a towing determination threshold corresponding to the torque, and detects towing a towed vehicle 11, when the acceleration is less than the towing determination threshold. When the acceleration is not less than the towing determination threshold, the towing detection unit 31 does not detect towing a towed vehicle 11. Towing determination thresholds corresponding to different torque values are prestored in the memory 22.

The predetermined state may be, for example, a state in which the vehicle 10 is stopped at a location without a gradient in the travel direction or is traveling at a fixed predetermined speed on a road without a gradient in the travel direction. The towing detection unit 31 determines the presence or absence of a gradient in the travel direction of the vehicle 10 by referring to the high-precision map and the position of the vehicle 10 indicated by the latest positioning signal obtained by the GPS receiver 4. When there is not a gradient in the travel direction of the vehicle 10, the towing detection unit 31 further determines whether the vehicle 10 is in the predetermined state, based on a sensor signal indicating the speed of the vehicle 10 obtained from the speed sensor, which is an example of the motion sensor 5.

When towing a towed vehicle 11 is detected, the towing detection unit 31 may further estimate the weight of the towed vehicle 11. In this case, the towing detection unit 31 identifies a weight corresponding to the measured torque and acceleration by referring to a reference table representing the relationship between torque and acceleration and the weight of the towed vehicle 11, and determines the identified weight as an estimated weight of the towed vehicle 11.

In the case where the equipment for towing a towed vehicle 11 is provided with a sensor that senses connection of a towed vehicle 11, the towing detection unit 31 may detect towing a towed vehicle 11 when a sensor signal from the sensor indicates that a towed vehicle 11 is connected.

The towing detection unit 31 notifies the control unit 32 and the determination unit 33 of the result of determination whether towing a towed vehicle 11 is detected.

The control unit 32 controls travel of the vehicle 10 by referring to a high-precision map read from the storage device 8. For example, the control unit 32 controls components of the vehicle 10 so that the vehicle 10 continues traveling on a host vehicle lane. To this end, the control unit 32 generates a planned trajectory extending in the host vehicle lane by referring to a high-precision map used for travel control. For example, the control unit 32 generates a planned trajectory extending along the center of the area between those lane lines demarcating the host vehicle lane which are represented in the high-precision map. The control unit 32 controls components of the vehicle 10 so that the vehicle 10 travels along the planned trajectory.

To achieve this, the control unit 32 detects the position of the vehicle 10 at predetermined intervals, and compares the detected position of the vehicle 10 with the planned trajectory. To detect the accurate position of the vehicle 10, the control unit 32 compares an image generated by the camera 2 with the high-precision map used for travel control. For example, assuming the position and orientation of the vehicle 10, the control unit 32 projects features on or around the road detected from an image onto the high-precision map or features on or around the road in the vicinity of the vehicle 10 represented in the high-precision map onto the image. The features on or around the road may be, for example, road markings such as lane lines or stop lines, or curbstones. The control unit 32 detects the position and orientation of the vehicle 10 for the case where the features detected from the image match those represented in the high-precision map the best, as the accurate position of the vehicle 10, and detects a lane on the high-precision map including the position of the vehicle as the host vehicle lane. Further, the control unit 32 determines lane lines detected at positions closest to the vehicle 10 in regions in the image respectively corresponding to the left and right of the vehicle 10, as the lane lines demarcating the host vehicle lane.

The control unit 32 uses initial values of the assumed position and orientation of the vehicle 10 and parameters of the camera 2, such as the focal length, the height of the mounted position, and the orientation, to determine the positions in the high-precision map or the image to which the features are projected. As the initial values of the position and orientation of the vehicle 10 is used the latest position of the vehicle 10 determined by the GPS receiver 4 or the position obtained by correcting, with odometry information, the position and orientation of the vehicle 10 estimated at the last detection of the position of the vehicle. The control unit 32 then calculates the degree of matching between the features on or around the road detected from the image and the corresponding features represented in the high-precision map (e.g., the inverse of the sum of squares of the distances between corresponding features).

The control unit 32 repeats the above-described processing while varying the assumed position and orientation of the vehicle 10, and detects the assumed position and orientation for the case where the degree of matching is a maximum, as the accurate position of the vehicle 10.

For example, the control unit 32 inputs an image into a classifier that has been trained to detect detection target features from an image, thereby detecting these features. As such a classifier, the control unit 32 can use a deep neural network (DNN) having architecture of a convolutional neural network (CNN) type, such as Single Shot MultiBox Detector or Faster R-CNN. Alternatively, as such a classifier, the control unit 32 may use a DNN having architecture of a self-attention network (SAN) type, such as Vision Transformer, or a classifier based on another machine learning technique, such as an AdaBoost classifier. Such a classifier is trained in advance with a large number of training images representing a detection target feature in accordance with a predetermined training technique, such as backpropagation, so as to detect the feature from an image.

The control unit 32 may measure the position of the vehicle 10 without using a high-precision map. In this case, the control unit 32 inputs an image obtained by the camera 2 into the classifier to detect those left and right lane lines demarcating the host vehicle lane which are represented in the image. The positions of lane lines in an image correspond one-to-one to the directions viewed from the camera that generated the image. Thus, based on reference positions in the horizontal direction of pixels representing the left and right lane lines closest to the bottom of the image as well as parameters of the camera 2, such as the focal length, the orientation, and the height of the mounted position, the control unit 32 estimates those positions of the left and right lane lines relative to the camera 2 which correspond to the reference positions in the image. The control unit 32 further determines the distances from the camera 2 to the left and right lane lines, based on the result of the estimation, the lengthwise direction of the lane lines, and the orientation of the camera 2, thereby measuring the position of the vehicle 10 in the lateral direction in the host vehicle lane.

When the measured position of the vehicle 10 is on the planned trajectory, the control unit 32 determines the steering angle of the vehicle 10 so that the vehicle 10 proceeds along the planned trajectory, and controls the steering of the vehicle 10 so that the steering angle is equal to the determined angle. When the measured position of the vehicle 10 is apart from the planned trajectory, the control unit 32 determines the steering angle of the vehicle 10 so that the vehicle 10 approaches the planned trajectory, and controls the steering of the vehicle 10 so that the steering angle is equal to the determined angle.

In addition, the control unit 32 identifies the regulation speed of the road being traveled by the vehicle 10, by referring to the current position of the vehicle 10 and the high-precision map, and sets the identified regulation speed as a target speed. The control unit 32 controls components of the vehicle 10 so that the speed of the vehicle 10 approaches the set target speed. Further, the control unit 32 controls the acceleration or deceleration of the vehicle 10 so as to keep at least a certain distance between the vehicle 10 and a vehicle traveling ahead of the vehicle 10 on the host vehicle lane. To achieve this, the control unit 32 inputs an image obtained by the camera 2 into a classifier that has been trained to detect a vehicle, thereby detecting other vehicles traveling in the vicinity of the vehicle 10. As such a classifier, the control unit 32 can use a classifier similar to that used for detecting features. Alternatively, the classifier used for detecting features may also be trained in advance to detect a vehicle. In this case, the control unit 32 can detect other vehicles as well as features by inputting an image into the classifier used for detecting features. Of the detected vehicles, the control unit 32 determines a vehicle whose bottom is in the region in the image sandwiched between the two lane lines demarcating the host vehicle lane as a vehicle ahead. In addition, the control unit 32 estimates the distance between the vehicle 10 and the vehicle ahead, based on the bottom position of an object region in the image representing the vehicle ahead and parameters of the camera 2, such as the orientation, the focal length, and the height of the mounted position. When the estimated distance to the vehicle ahead is less than the certain distance, the control unit 32 sets the acceleration or deceleration of the vehicle 10 so as to decelerate the vehicle 10. When the estimated distance to the vehicle ahead is not less than the certain distance, the control unit 32 sets the acceleration or deceleration of the vehicle 10 so that the speed of the vehicle 10 approaches the target speed.

When acceleration or deceleration is set as described above, the control unit 32 sets the degree of accelerator opening or the amount of braking according to the set acceleration or deceleration. At this setting, the control unit 32 may vary the degree of accelerator opening or the amount of braking, depending on whether towing a towed vehicle 11 is detected. For example, the control unit 32 may set a greater degree of accelerator opening or amount of braking when towing a towed vehicle 11 is detected than when towing a towed vehicle 11 is not detected.

The control unit 32 determines the amount of fuel injection according to the set degree of accelerator opening, and outputs a control signal depending on the amount of fuel injection to a fuel injector of an engine of the vehicle 10. Alternatively, the control unit 32 determines electric power to be supplied to a motor according to the set degree of accelerator opening, and controls a driving circuit of the motor so that the determined electric power is supplied to the motor. Alternatively, the control unit 32 outputs a control signal depending on the set amount of braking to the brake of the vehicle 10.

The control unit 32 may stop autonomous driving control or the vehicle 10 in the case where the driver disobeys a request for involvement in driving even after a predetermined period from notification to the driver of the request. For example, the control unit 32 may stop autonomous driving control and transfer driving control to the driver, in the case where the ECU 9 does not receive a signal indicating that the steering wheel is held from a touch sensor (not illustrated) provided in the steering even after a predetermined period from notification of a hands-on request. The control unit 32 may stop the vehicle 10 in the case where the ECU 9 does not receive a signal indicating that the steering wheel is held from the touch sensor provided in the steering or a signal indicating that the steering, the accelerator, or the brake is operated even after a predetermined period from notification of a transition demand.

The determination unit 33 determines whether an involvement requirement is satisfied. In the present embodiment, the determination unit 33 compares the distances from the vehicle 10 to the left and right lane lines demarcating the host vehicle lane (hereafter “lateral distances”) with a hands-on request threshold. When the left or right lateral distance is less than the hands-on request threshold, the determination unit 33 determines that the involvement requirement is satisfied. When determining that the involvement requirement is satisfied, the determination unit 33 notifies the notification processing unit 34 of the result of the determination. The hands-on request threshold is an example of the distance threshold.

The determination unit 33 sets the hands-on request threshold to a higher value when towing a towed vehicle 11 is detected than when towing a towed vehicle 11 is not detected. In other words, the determination unit 33 makes the involvement requirement less strict when towing a towed vehicle 11 is detected than when towing a towed vehicle 11 is not detected. For example, the determination unit 33 sets the hands-on request threshold for the case where towing a towed vehicle 11 is not detected to 0.2 m to 0.3 m, and the hands-on request threshold for the case where towing a towed vehicle 11 is detected to 0.4 m to 0.5 m. Setting the hands-on request threshold in this way enables requesting the driver to hold the steering wheel before the vehicle 10 approaches a lane line too much, even when the vehicle 10 is towing a towed vehicle 11.

Based on the positions in an image of lane lines detected from the image and parameters of the camera 2, the determination unit 33 estimates the positions of the lane lines relative to the camera 2, as described in relation to the control unit 32. For each of the left and right sides of the vehicle 10, the determination unit 33 further determines the lateral distance by subtracting the distance from the mounted position of the camera 2 to the side surface of the vehicle 10 from the distance from the camera 2 to the lane line.

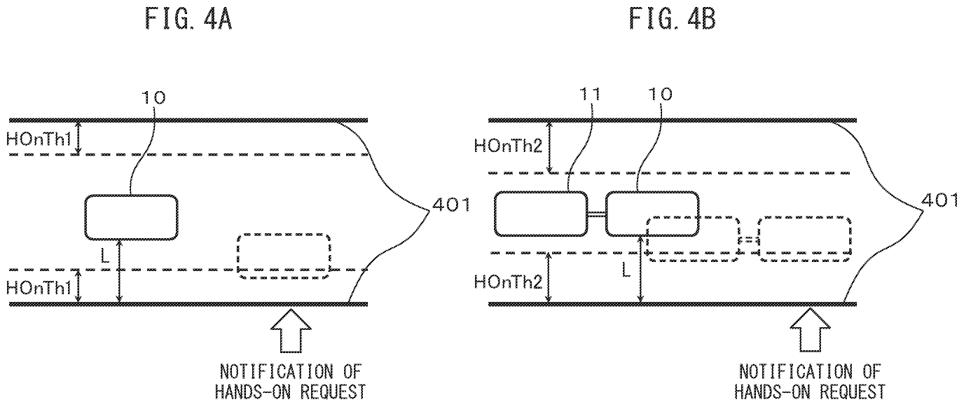

FIGS. 4A and 4B illustrate an example of the relationship between the hands-on request threshold for the case where towing a towed vehicle 11 is not detected and the hands-on request threshold for the case where towing a towed vehicle 11 is detected. In the example illustrated in FIG. 4A, the vehicle 10 is not towing another vehicle, whereas in the example illustrated in FIG. 4B, the vehicle 10 is towing a towed vehicle 11.

In the case where towing a towed vehicle 11 is not detected, a first value HOnTh1 is used as the hands-on request threshold, as illustrated in FIG. 4A. Thus, in the case where towing a towed vehicle 11 is not detected, when the lateral distance L between a left or right lane line 401 and the vehicle 10 falls below the hands-on request threshold HOnTh1, it is determined that an involvement requirement is satisfied, and notification of a hands-on request is given.

In the case where towing a towed vehicle 11 is detected, a second value HOnTh2 is used as the hands-on request threshold, as illustrated in FIG. 4B. Thus, in the case where towing a towed vehicle 11 is detected, when the lateral distance L between a left or right lane line 401 and the vehicle 10 falls below the hands-on request threshold HOnTh2, it is determined that an involvement requirement is satisfied, and notification of a hands-on request is given. The second value HOnTh2 is set greater than the first value HOnTh1. This results in the involvement requirement being more easily satisfied when towing a towed vehicle 11 is detected than when towing a towed vehicle 11 is not detected. Hence, notification of a hands-on request will be given before the vehicle 10 approaches the lane line 401 too much, even when the vehicle 10 is towing a towed vehicle 11.

Further, the determination unit 33 compares the lateral distances to the left and right lane lines with a transition demand threshold. When the left or right lateral distance is less than the transition demand threshold, the determination unit 33 determines that the involvement requirement is satisfied. The transition demand threshold is another example of the distance threshold.

The determination unit 33 sets the transition demand threshold to a higher value when towing a towed vehicle 11 is detected than when towing a towed vehicle 11 is not detected. For example, the determination unit 33 sets the transition demand threshold for the case where towing a towed vehicle 11 is not detected to 0.1 m to 0.2 m, and the transition demand threshold for the case where towing a towed vehicle 11 is detected to 0.2 m to 0.3 m. Setting the transition demand threshold in this way enables the determination unit 33 to transfer driving control to the driver before the vehicle 10 approaches a lane line too much, even when the vehicle 10 is towing a towed vehicle 11.

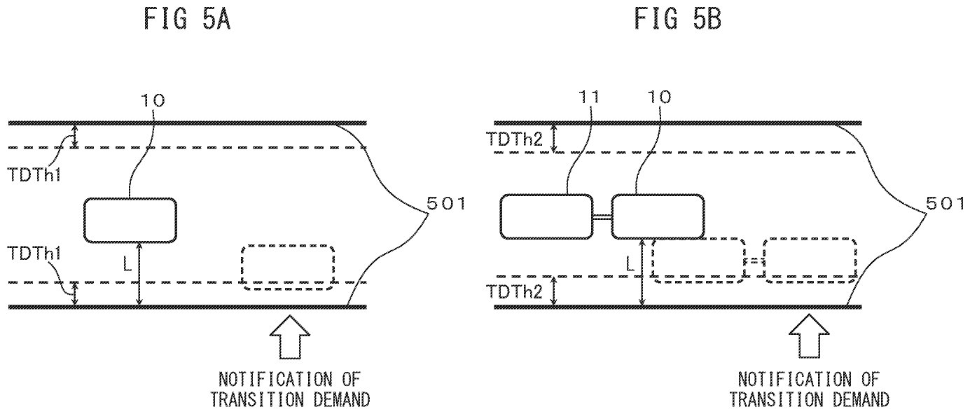

FIGS. 5A and 5B illustrate an example of the relationship between the transition demand threshold for the case where towing a towed vehicle 11 is not detected and the transition demand threshold for the case where towing a towed vehicle 11 is detected. In the example illustrated in FIG. 5A, towing a towed vehicle 11 is not detected, whereas in the example illustrated in FIG. 5B, towing a towed vehicle 11 is detected.

In the case where towing a towed vehicle 11 is not detected, a first value TDTh1 is used as the transition demand threshold, as illustrated in FIG. 5A. Thus, in the case where towing a towed vehicle 11 is not detected, when the lateral distance L between a left or right lane line 501 and the vehicle 10 falls below the transition demand threshold TDTh1, it is determined that an involvement requirement is satisfied, and notification of a transition demand is given.

In the case where towing a towed vehicle 11 is detected, a second value TDTh2 is used as the transition demand threshold, as illustrated in FIG. 5B. Thus, in the case where towing a towed vehicle 11 is detected, when the lateral distance L between a left or right lane line 501 and the vehicle 10 falls below the transition demand threshold TDTh2, it is determined that an involvement requirement is satisfied, and notification of a transition demand is given. The second value TDTh2 is set greater than the first value TDTh1. This results in the involvement requirement being more easily satisfied when towing a towed vehicle 11 is detected than when towing a towed vehicle 11 is not detected. Hence, notification of a transition demand will be given before the vehicle 10 approaches the lane line 501 too much, even when the vehicle 10 is towing a towed vehicle 11.

Upon receiving the result of determination that the involvement requirement is satisfied from the determination unit 33, the notification processing unit 34 notifies the driver of a request corresponding to the satisfied involvement requirement via the notification device 7.

When it is determined that the lateral distance has fallen below the hands-on request threshold, as described above, the notification processing unit 34 notifies the driver of a hands-on request via the notification device 7. When it is determined that the lateral distance has fallen below the transition demand threshold, the notification processing unit 34 notifies the driver of a transition demand via the notification device 7.

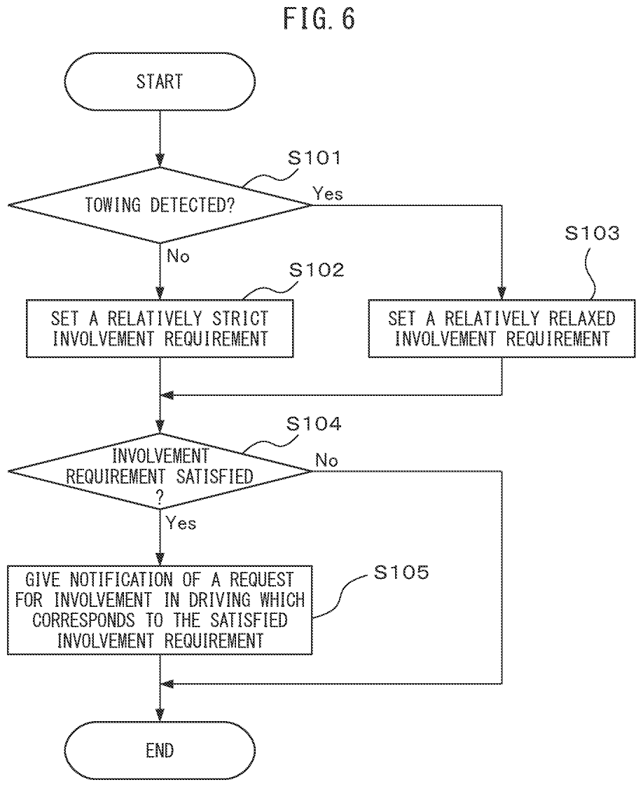

FIG. 6 is an operation flowchart of the vehicle control process related to a change of the degree of the driver's involvement in driving according to the first embodiment. The processor 23 executes the vehicle control process at predetermined intervals in accordance with the operation flowchart described below.

The towing detection unit 31 of the processor 23 determines whether towing a towed vehicle 11 by the vehicle 10 is detected (step S101).

When towing a towed vehicle 11 is not detected (No in step S101), the determination unit 33 of the processor 23 sets a relatively strict involvement requirement (step S102). When towing a towed vehicle 11 is detected (Yes in step S101), the determination unit 33 sets a relatively relaxed involvement requirement (step S103).

The determination unit 33 determines whether the set involvement requirement is satisfied (step S104). When the involvement requirement is satisfied (Yes in step S104), the notification processing unit 34 of the processor 23 notifies the driver of a request for involvement in driving which corresponds to the satisfied involvement requirement via the notification device 7 (step S105).

When the involvement requirement is not satisfied in step S104 (No in step S104) or after step S105, the processor 23 terminates the vehicle control process.

As has been described above, the vehicle controller determines whether an involvement requirement for requesting a driver of the host vehicle to be involved in driving the host vehicle is satisfied, and gives notification of a request for involvement in driving via a notification device provided in the vehicle interior, when it is determined that the involvement requirement is satisfied. The vehicle controller makes the involvement requirement less strict when towing a towed vehicle is detected than when towing a towed vehicle is not detected. This results in the involvement requirement being easily satisfied when towing a towed vehicle is detected. Thus the vehicle controller can request the driver to be involved in driving before the host vehicle falls into an unstable state, even when the host vehicle is towing a towed vehicle. As a result, the vehicle controller can appropriately set timing for increasing the degree of involvement in driving of a driver of a vehicle towing a towed vehicle and being under autonomous driving control.

According to a modified example, when towing a towed vehicle 11 is detected, the determination unit 33 may adjust the hands-on request threshold or the transition demand threshold, depending on the weight of the towed vehicle 11. For example, the determination unit 33 may increase the hands-on request threshold or the transition demand threshold as the weight of the towed vehicle 11 estimated by the towing detection unit 31 increases. Specifically, the hands-on request threshold or the transition demand threshold may also increase continuously as the estimated weight of the towed vehicle 11 increases. Alternatively, the hands-on request threshold or the transition demand threshold may be set stepwise. In this case, every time the estimated weight of the towed vehicle 11 increases by a predetermined value, the determination unit 33 increases the hands-on request threshold or the transition demand threshold by a predetermined stepped amount.

Similarly, when towing a towed vehicle 11 is detected, the determination unit 33 may adjust the hands-on request threshold or the transition demand threshold, depending on the volume of the towed vehicle 11. For example, the determination unit 33 may increase the hands-on request threshold or the transition demand threshold as the volume of the towed vehicle 11 estimated by the towing detection unit 31 increases. In this case, information indicating the volume of the towed vehicle 11 may be prestored in the memory 22.

By adjusting the hands-on request threshold or the transition demand threshold in this way, depending on the weight or volume of the towed vehicle 11, the determination unit 33 can request the driver to be involved in driving at more appropriate timing before the vehicle 10 approaches a lane line too much.

In addition, when towing a towed vehicle 11 is detected, the determination unit 33 may adjust the hands-on request threshold or the transition demand threshold, depending on the type of loads on the towed vehicle 11. For example, the determination unit 33 may make the hands-on request threshold greater when the type of loads on the towed vehicle 11 is breakables that are relatively vulnerable to vibration or impact, such as precision machines or fragile articles, than when the type of loads is not breakables. Similarly, the determination unit 33 may make the transition demand threshold greater when the type of loads on the towed vehicle 11 is breakables than when the type of loads is not breakables. Information indicating the type of loads of the towed vehicle 11 is inputted via a user interface provided in the interior of the vehicle 10 and stored in the memory 22. The determination unit 33 refers to the information to determine the type of loads of the towed vehicle 11.

In addition, when towing a towed vehicle 11 is detected, the determination unit 33 may increase the hands-on request threshold or the transition demand threshold as the degree of reliability of a detected lane line demarcating the host vehicle lane decreases. In this case, the determination unit 33 may use a confidence score of the lane line outputted by the classifier used for detecting lane lines, as the degree of reliability.

According to another modified example, the determination unit 33 may determine whether the involvement requirement is satisfied, based on motion of the vehicle 10, the driver's state, or conditions around the vehicle 10, instead of lateral distances. In this case also, the determination unit 33 makes the involvement requirement less strict when towing a towed vehicle 11 is detected than when towing a towed vehicle 11 is not detected. The relaxation of the involvement requirement for the case where towing a towed vehicle 11 is detected enables the determination unit 33 to request the driver to be involved in driving before the vehicle 10 falls into an unstable state caused by motion of the vehicle 10, the driver's state, or conditions around the vehicle 10, even when the vehicle 10 is towing a towed vehicle 11.

For example, the determination unit 33 determines that the involvement requirement is satisfied, when the speed of the vehicle 10 measured by the speed sensor, which is an example of the motion sensor 5, is greater than a regulation speed of a road being traveled by the vehicle 10 by more than a predetermined speed threshold. The notification processing unit 34 then notifies the driver of a hands-on request via the notification device 7. In this case, the determination unit 33 sets the speed threshold to a lower value when towing a towed vehicle 11 is detected than when towing a towed vehicle 11 is not detected. This enables the determination unit 33 to appropriately request the driver to be involved in driving, when the speed of the vehicle 10 exceeds the regulation speed. The determination unit 33 identifies a road including the position of the vehicle 10 indicated by the latest positioning information obtained by the GPS receiver 4 as the road being traveled by the vehicle 10, by referring to the high-precision map. The determination unit 33 then identifies the regulation speed of the road being traveled by the vehicle 10, by referring to the high-precision map. Alternatively, the determination unit 33 may input an image generated by the camera 2 into a classifier that has been trained to detect a regulation speed represented in a speed sign, thereby identifying the regulation speed of the road being traveled by the vehicle 10. As such a classifier, the determination unit 33 can use a classifier similar to the classifier used for detecting features, which has been described in relation to the control unit 32.

Further, the determination unit 33 determines that the involvement requirement is satisfied, when the vehicle 10 is traveling on a section whose regulation speed is less than a predetermined speed. The notification processing unit 34 then notifies the driver of a hands-on request via the notification device 7. In this case, the determination unit 33 sets the predetermined speed greater when towing a towed vehicle 11 is detected than when towing a towed vehicle 11 is not detected. This enables the determination unit 33 to appropriately request the driver to be involved in driving, when the regulation speed of the road being traveled by the vehicle 10 is low and more careful control of the vehicle 10 is required.

Alternatively, the determination unit 33 determines that the involvement requirement is satisfied, when the radius of curvature of a curve in a section being traveled by the vehicle 10 or extending to a predetermined distance (e.g., several hundred meters to 1 km) away is less than a predetermined curvature radius threshold. When the radius of curvature of the curve is less than the predetermined curvature radius threshold, the notification processing unit 34 notifies the driver of a hands-on request via the notification device 7. Alternatively, the notification processing unit 34 may notify the driver of a transition demand via the notification device 7. In this case, the determination unit 33 sets the curvature radius threshold to a higher value when towing a towed vehicle 11 is detected than when towing a towed vehicle 11 is not detected. This enables the determination unit 33 to appropriately request the driver to be involved in driving, depending on the radius of curvature of the curve that is being traveled or will be traveled by the vehicle 10. In the same manner as described above, the determination unit 33 identifies a road including the position of the vehicle 10 indicated by the latest positioning information obtained by the GPS receiver 4 as the road being traveled by the vehicle 10, by referring to the high-precision map. The determination unit 33 further identifies the radius of curvature of the curve included in the section from the current position of the vehicle 10 to a predetermined distance away in the road being traveled by the vehicle 10, by referring to the travel direction of the vehicle 10 indicated by an orientation sensor (not illustrated) mounted on the vehicle 10 and the high-precision map used for travel control.

Alternatively, the determination unit 33 determines that the involvement requirement is satisfied, when the gradient of a road in a section being traveled by the vehicle or extending to a predetermined distance away is not less than a predetermined gradient threshold. The notification processing unit 34 then notifies the driver of a hands-on request via the notification device 7. Alternatively, the notification processing unit 34 may notify the driver of a transition demand via the notification device 7. In this case, the determination unit 33 sets the gradient threshold to a lower value when towing a towed vehicle 11 is detected than when towing a towed vehicle 11 is not detected. This enables the determination unit 33 to appropriately request the driver to be involved in driving, depending on the gradient of the road section that is being traveled or will be traveled by the vehicle 10. In the same manner as described above, the determination unit 33 identifies a road including the position of the vehicle 10 indicated by the latest positioning information obtained by the GPS receiver 4 as the road being traveled by the vehicle 10, by referring to the high-precision map. The determination unit 33 further identifies the gradient of the section from the current position of the vehicle 10 to a predetermined distance away in the road being traveled by the vehicle 10, by referring to the travel direction of the vehicle 10 indicated by an orientation sensor (not illustrated) mounted on the vehicle 10 and the high-precision map.

Alternatively, the determination unit 33 determines that the involvement requirement is satisfied, when an unheld period during which the steering wheel is not held by the driver has continued for more than a predetermined unheld period threshold. The notification processing unit 34 then notifies the driver of a hands-on request via the notification device 7. In this case, the unheld period threshold is set to a lower value when towing a towed vehicle 11 is detected than when towing a towed vehicle 11 is not detected. The determination unit 33 determines the time elapsed since the last reception by the ECU 9 of a signal indicating that the steering wheel is held from the touch sensor provided in the steering, as the unheld period.

Alternatively, the determination unit 33 determines that the involvement requirement is satisfied, when the driver has been ignoring a face lost warning, a looking-aside warning, an eye-closing warning, or a no-hand driving warning issued via the notification device 7 for more than a predetermined time threshold. The notification processing unit 34 then notifies the driver of a hands-on request via the notification device 7. In this case, the time threshold is set to a lower value when towing a towed vehicle 11 is detected than when towing a towed vehicle 11 is not detected.

The determination unit 33 inputs a driver image generated by the driver monitoring camera 3 into a classifier that has been trained to detect a driver's face, thereby determining whether a face region representing the driver's face can be detected in the driver image. As such a classifier, the determination unit 33 can use a classifier similar to that used by the control unit 32 for detecting features. When no face region is detected, the determination unit 33 determines that the driver is in a face lost state in which his/her face cannot be detected. When the face lost state has continued for a predetermined period, the determination unit 33 notifies the driver of a face lost warning via the notification device 7. In the case where the driver's face is detected from driver images generated after the notification of the face lost warning or where the driver takes action to respond to the face lost warning, the determination unit 33 determines that the driver has responded to the face lost warning. In the case where the driver's face is not detected from driver images even after the notification of the face lost warning and where the driver does not take action to respond to the face lost warning, the determination unit 33 determines that the driver has ignored the face lost warning. The action to respond is taken, for example, by operating a predetermined switch provided in the vehicle interior or by the driver uttering a predetermined word. The driver's voice is collected by a speaker provided in the vehicle interior and outputted to the ECU 9 as a voice signal. The processor 23 executes a predetermined voice recognition process, such as GMM-HMM or DNN-HMM, on the voice signal to determine whether the driver has uttered the predetermined word.

Further, the determination unit 33 matches the face region to a three-dimensional face model to determine the orientation of the driver's face. When the orientation of the driver's face is outside a predetermined angle range centered in the travel direction of the vehicle 10, the determination unit 33 determines that the driver is in a looking-aside state in which he/she is looking aside. Alternatively, the determination unit 33 may detect the driver's looking direction, and determine that he/she is in the looking-aside state, when the detected looking direction is outside the angle range. In this case, the determination unit 33 applies an edge detection filter to the face region to detect edges extending in the horizontal direction, or inputs the face region into a classifier, thereby detecting the upper and lower eyelids of the driver's left or right eye. In addition, the determination unit 33 executes template matching on the region surrounded by the upper and lower eyelids to detect the pupillary centroid and a corneal reflection image of the light source. Based on the positional relationship between the pupillary centroid and the corneal reflection image of the light source, the determination unit 33 detects the looking direction. When the looking-aside state has continued for a predetermined period, the determination unit 33 notifies the driver of a looking-aside warning via the notification device 7. When the driver's face orientation or looking direction detected after the notification of the looking-aside warning starts to be within the angle range, i.e., when the looking-aside state is finished, the determination unit 33 determines that the driver has responded to the looking-aside warning. When the looking-aside state is not finished even after the notification of the looking-aside warning, the determination unit 33 determines that the driver has ignored the looking-aside warning.

In addition, the determination unit 33 calculates the ratio of the distance between the detected upper and lower eyelids to a reference distance between the upper and lower eyelids for the case where the driver's eyes are opened completely, as an eye-closing level. The reference distance is prestored in the memory 22. When the eye-closing level is not higher than a predetermined eye-closing threshold, the determination unit 33 determines that the driver is in an eye-closing state in which his/her eyes are closed. When the eye-closing state has continued for a predetermined period, the determination unit 33 notifies the driver of an eye-closing warning via the notification device 7. When the driver's eye-closing level detected after the notification of the eye-closing warning exceeds the eye-closing threshold, i.e., when the eye-closing state is finished, the determination unit 33 determines that the driver has responded to the eye-closing warning. When the eye-closing state is not finished even after the notification of the eye-closing warning, the determination unit 33 determines that the driver has ignored the eye-closing warning.

When the ECU 9 receives a signal indicating that the steering wheel is not held from the touch sensor provided in the steering, the determination unit 33 determines that that the driver is in a no-hand driving state in which he/she is not holding the steering wheel. When the no-hand driving state has continued for more than a predetermined time under autonomous driving control of the vehicle 10 by the ECU 9 at a level at which the driver is required to hold the steering wheel, the determination unit 33 notifies the driver of a no-hand driving warning via the notification device 7. When the ECU 9 receives a signal indicating that the steering wheel is held from the touch sensor after the notification of the no-hand driving warning, the determination unit 33 determines that the no-hand driving state is finished. When the ECU 9 does not receive a signal indicating that the steering wheel is held from the touch sensor even after the notification of the no-hand driving warning, the determination unit 33 determines that the driver has ignored the no-hand driving warning.

The determination unit 33 may determine whether all of the involvement requirements in the above-described embodiment or modified examples are satisfied, or determine whether one or more of these involvement requirements are satisfied.

### Second Embodiment

The following describes a second embodiment. In the second embodiment, the processor 23 changes an interruption condition for determining whether to interrupt a lane change process on the vehicle 10, depending on whether the vehicle 10 is towing a towed vehicle, after the start of the lane change process.

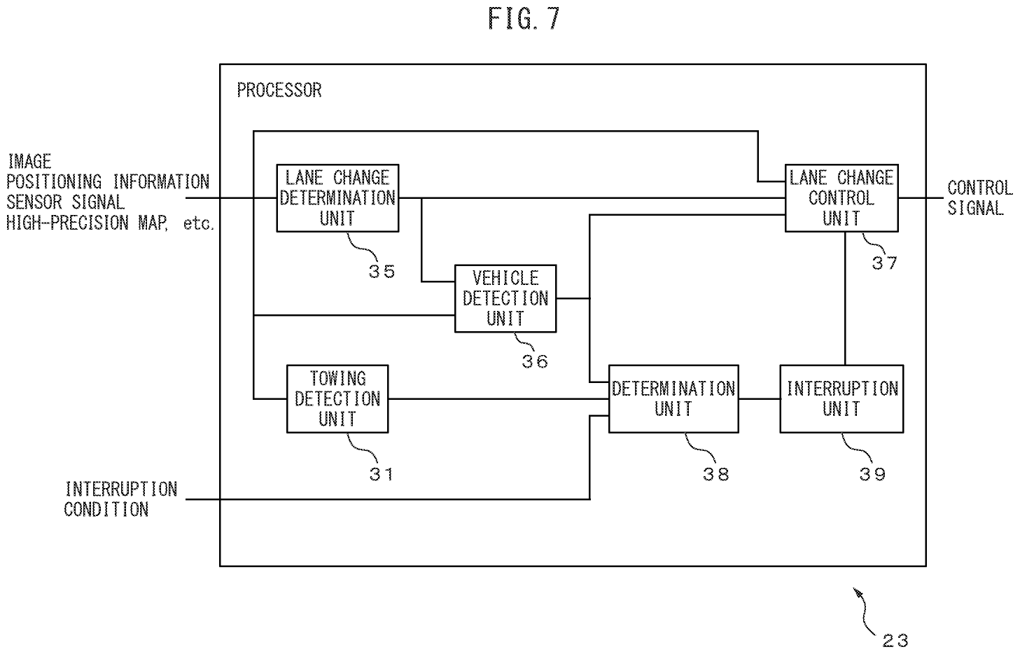

FIG. 7 is a functional block diagram of the processor 23, related to a vehicle control process according to the second embodiment. The processor 23 includes a towing detection unit 31, a lane change determination unit 35, a vehicle detection unit 36, a lane change control unit 37, a determination unit 38, and an interruption unit 39. These units included in the processor 23 are functional modules, for example, implemented by a computer program executed by the processor 23, or may be dedicated operating circuits provided in the processor 23. In the second embodiment, the same reference number as in the first embodiment is assigned to what executes the same processing in the first and second embodiments. Regarding details of the unit in the second embodiment which has a counterpart in the first embodiment, see the description of the first embodiment.

The towing detection unit 31 detects that the vehicle 10 is towing a towed vehicle 11, as in the first embodiment. The towing detection unit 31 notifies the lane change control unit 37 and the determination unit 38 of the result of detection of towing.

The lane change determination unit 35 determines whether a predetermined condition for applying lane change control to the vehicle 10 is satisfied. For example, when the driver operates a direction indicator, the lane change determination unit 35 determines that the predetermined condition is satisfied, and determines to apply the control of a lane change to an adjacent lane adjacent on the side indicated by the direction indicator with respect to the host vehicle lane. Alternatively, the lane change determination unit 35 may determine that the predetermined condition is satisfied, and determine to apply lane change control, when the host vehicle lane differs from a lane leading toward a destination of the vehicle 10, or at the time of passing a vehicle ahead or returning from a passing lane to a travel lane.

To determine whether the host vehicle lane differs from the lane leading toward a destination of the vehicle 10, the lane change determination unit 35 refers to a travel route to the destination of the vehicle 10 received by the ECU 9 from a navigation device (not illustrated), the current position of the vehicle 10, and the high-precision map. The lane change determination unit 35 determines whether there is a fork at which the lane leading toward the destination diverges from the road being traveled by the vehicle 10, in a section from the current position of the vehicle 10 to a predetermined distance away. When there is a fork, the lane change determination unit 35 determines whether the host vehicle lane differs from the lane leading toward the destination. When the host vehicle lane differs from the lane leading toward the destination, the lane change determination unit 35 determines to apply lane change control one or more times in which the lane leading toward the destination is a target lane. As described in relation to the control unit 32 in the first embodiment, the lane change determination unit 35 measures the accurate position of the vehicle 10 by comparing an image generated by the camera 2 with the high-precision map, and identifies a lane including the measured position of the vehicle 10 among the lanes represented in the high-precision map as the host vehicle lane.

The lane change determination unit 35 determines to apply lane change control to pass a vehicle traveling ahead of the vehicle 10, in the case where the speed of the vehicle 10 falls below a predetermined speed threshold and where the distance between the vehicle ahead and the vehicle 10 has not been greater than a predetermined distance for a predetermined time. The predetermined time may be, for example, several seconds to several tens of seconds. In this case, the lane change determination unit 35 sets a passing lane among the lanes adjacent to the host vehicle lane as a target lane that is the destination of the lane change. Of other vehicles traveling in the vicinity of the vehicle 10 (hereafter referred to as “vicinity vehicles” for convenience of description) which are detected by the vehicle detection unit 36, the lane change determination unit 35 identifies a vicinity vehicle represented in an object region within that area in an image generated by the camera 2 which corresponds to the front of the vehicle 10, as a vehicle ahead. The predetermined speed threshold is set, for example, to a predetermined offset value (e.g., 10 km/h to 20 km/h) subtracted from the legally permitted speed or the regulation speed of the road being traveled by the vehicle 10. Thus the lane change determination unit 35 refers to the current position of the vehicle 10 and the high-precision map to identify the legally permitted speed or the regulation speed of the road being traveled by the vehicle 10, thereby setting the speed threshold. In addition, the lane change determination unit 35 determines the distance between the vehicle 10 and the vehicle ahead, based on the positional relationship between the vehicle 10 and the vehicle ahead detected by the vehicle detection unit 36.

In addition, the lane change determination unit 35 determines to apply lane change control to return the vehicle 10 to a travel lane, in the case where the host vehicle lane is a passing lane and where the vehicle 10 has been traveling on the passing lane for the most recent predetermined period. The lane change determination unit 35 determines whether the host vehicle lane is a passing lane, by referring to the high-precision map. In this case, the lane change determination unit 35 sets one of the travel lanes in the road being traveled by the vehicle 10 as a target lane that is the destination of the lane change.

When determining to apply lane change control to the vehicle 10, the lane change determination unit 35 notifies the result of the determination and the bearing of an adjacent lane that is the destination of the lane change viewed from the lane being traveled by the vehicle 10 (right or left) to the vehicle detection unit 36, the lane change control unit 37, and the determination unit 38.

The vehicle detection unit 36 detects a vicinity vehicle as well as a relative position and a relative speed between the vicinity vehicle and the vehicle 10. In particular, the vehicle detection unit 36 detects a relative position and a relative speed between the vehicle 10 and a vicinity vehicle traveling on an adjacent lane that is the destination of the lane change (hereafter simply an “adjacent lane” or a “destination adjacent lane”). Specifically, the vehicle detection unit 36 inputs an image obtained from the camera 2 into a classifier to detect a vicinity vehicle. As such a classifier, the vehicle detection unit 36 can use a classifier similar to that described in relation to the control unit 32 in the first embodiment. The classifier outputs information for identifying an object region including a vicinity vehicle detected in an inputted image and information indicating the type of the detected vicinity vehicle (e.g., an ordinary passenger car, a large-size vehicle, or a two-wheeler).

When a vicinity vehicle is detected, the vehicle detection unit 36 determines whether the vicinity vehicle is traveling on the adjacent lane. The bottom position of the object region including the vicinity vehicle is assumed to correspond to the position where the vicinity vehicle is in contact with the road surface. Further, the positions in an image correspond one-to-one to the directions viewed from the camera that generated the image, as described above. Thus the vehicle detection unit 36 can estimate the distance from the camera 2 to the vicinity vehicle and the direction from the vehicle 10 to the vicinity vehicle, by referring to the bottom position of the object region in the image and parameters of the camera 2, such as the height of the mounted position and the orientation. Alternatively, the vehicle detection unit 36 may estimate the distance from the camera 2 to the vicinity vehicle, based on the horizontal width of the object region including the vicinity vehicle and the number of reference pixels in an image corresponding to a reference vehicle width of the type of the vicinity vehicle for the case where the distance between the vehicles is a reference distance.

In the case where the vehicle 10 is equipped with a range sensor (not illustrated), the vehicle detection unit 36 may detect a vicinity vehicle, based on a ranging signal. In this case also, the vehicle detection unit 36 detects a vicinity vehicle by inputting a ranging signal into a classifier that has been trained to detect a vicinity vehicle from a ranging signal. As the classifier for detecting a vicinity vehicle from a ranging signal, the vehicle detection unit 36 can use a DNN having architecture of a CNN or SAN type. Alternatively, the vehicle detection unit 36 may detect a vicinity vehicle in accordance with another technique to detect a vicinity vehicle from a ranging signal. In this case, the vehicle detection unit 36 determines the direction in which a vicinity vehicle is detected in the ranging signal as the direction from the vehicle 10 to the vicinity vehicle. Further, the vehicle detection unit 36 determines the distance indicated by the ranging signal regarding the direction as an estimated distance from the vehicle 10 to the vicinity vehicle.

Based on the estimated direction and distance, the vehicle detection unit 36 estimates the distance from the vehicle 10 to the vicinity vehicle along a direction perpendicular to the travel direction of the vehicle 10 (hereafter referred to as the “inter-vehicle lateral distance” for convenience of description). In the case where the inter-vehicle lateral distance is within a predetermined distance range corresponding to the width of the adjacent lane at the current position of the vehicle 10 and where the direction from the vehicle 10 to the vicinity vehicle is the same as the bearing of the destination adjacent lane relative to the host vehicle lane, the vehicle detection unit 36 determines that the vicinity vehicle is traveling on the adjacent lane. The vehicle detection unit 36 identifies the predetermined distance range at the current position of the vehicle 10 by referring to the high-precision map.

Alternatively, the vehicle detection unit 36 may detect lane lines represented in an image, together with a vicinity vehicle, by inputting the image into the classifier. In this case, the classifier is trained in advance so that lane lines can also be detected. The vehicle detection unit 36 identifies a region in the image sandwiched between two lane lines in ascending order of distance from the position of the vehicle 10 in the bearing of the destination adjacent lane (right or left) as a region representing the adjacent lane in the image. When the bottom of the object region representing the vicinity vehicle is within the region corresponding to the adjacent lane, the vehicle detection unit 36 determines that the vicinity vehicle is traveling on the adjacent lane.

The vehicle detection unit 36 executes the above-described processing on time-series images generated by the camera 2 or time-series ranging signals generated by the range sensor to estimate the positions of the vicinity vehicle relative to the vehicle 10 at the times of generation of the images or the ranging signals. In addition, the vehicle detection unit 36 determines the changes in the position of the vicinity vehicle relative to the vehicle 10 from the relative positions at the times of generation of individual images or ranging signals in the most recent certain period arranged in chronological order, and estimates the speed of the vicinity vehicle relative to the vehicle 10, based on the changes in the relative position.

When multiple vicinity vehicles are detected, the vehicle detection unit 36 applies a predetermined tracking technique, such as KLT tracking, to track the individual vicinity vehicles over the time-series images or ranging signals. The vehicle detection unit 36 estimates the position and speed of each tracked vicinity vehicle relative to the vehicle 10.

For each vicinity vehicle determined to be traveling on the destination adjacent lane, the vehicle detection unit 36 notifies the position and speed of the vicinity vehicle relative to the vehicle 10 to the lane change control unit 37 and the determination unit 38.

When notified by the lane change determination unit 35 of the result of determination that lane change control is to be applied to the vehicle 10, the lane change control unit 37 executes lane change control to make the vehicle 10 enter the adjacent lane. When instructed by the interruption unit 39 to interrupt lane change control before completion of the lane change control, the lane change control unit 37 interrupts execution of the lane change control. Then the lane change control unit 37 controls components of the vehicle 10 so that the vehicle 10 continues traveling on the host vehicle lane.

When starting execution of lane change control, the lane change control unit 37 sets a planned trajectory such that the vehicle 10 will move from the host vehicle lane to the adjacent lane. Upon setting a planned trajectory, the lane change control unit 37 controls components of the vehicle 10 so that the vehicle 10 travels along the planned trajectory. To achieve this, the lane change control unit 37 measures the position of the vehicle 10 at predetermined intervals, and compares the measured position of the vehicle 10 with the planned trajectory. As described in relation to the control unit 32 in the first embodiment, the lane change control unit 37 measures the accurate position of the vehicle 10 by comparing an image obtained by the camera 2 with the high-precision map. When the measured position of the vehicle 10 is on the planned trajectory, the lane change control unit 37 determines the steering angle of the vehicle 10 so that the vehicle 10 moves along the planned trajectory, and controls the steering of the vehicle 10 so that the steering angle is equal to the determined angle. When the measured position of the vehicle 10 is apart from the planned trajectory, the lane change control unit 37 determines the steering angle of the vehicle 10 so that the vehicle 10 approaches the planned trajectory, and controls the steering of the vehicle 10 so that the steering angle is equal to the determined angle.

In the case where a vicinity vehicle is traveling on the adjacent lane ahead of or beside the vehicle 10, the lane change control unit 37 sets the acceleration or deceleration of the vehicle 10 so that the distance between the vicinity vehicle and the vehicle 10 will not be less than a predetermined distance threshold when the vehicle 10 enters the adjacent lane. To this end, the lane change control unit 37 refers to the relative position and the relative speed of the vicinity vehicle detected by the vehicle detection unit 36. When the distance between the vehicle 10 and the vicinity vehicle in the travel direction of the vehicle 10, which is determined from the relative position between the vehicle 10 and the vicinity vehicle, is less than the distance threshold, the lane change control unit 37 reduces the speed of the vehicle 10 to below that of the vicinity vehicle, based on the relative speed. When the distance between the vehicle 10 and the vicinity vehicle in the travel direction of the vehicle 10 is not less than the distance threshold, the lane change control unit 37 sets acceleration or deceleration, based on the relative speed, so that the vehicle 10 is as fast as or slower than the vicinity vehicle.

The lane change control unit 37 sets the degree of accelerator opening or the amount of braking according to the set acceleration or deceleration. The lane change control unit 37 determines the amount of fuel injection according to the set degree of accelerator opening, and outputs a control signal depending on the amount of fuel injection to a fuel injector of an engine of the vehicle 10. Alternatively, the lane change control unit 37 determines electric power to be supplied to a motor according to the set degree of accelerator opening, and controls a driving circuit of the motor so that the determined electric power is supplied to the motor. Alternatively, the lane change control unit 37 outputs a control signal depending on the set amount of braking to the brake of the vehicle 10.

When the vehicle 10 starts to travel completely inside the adjacent lane, the lane change control unit 37 finishes lane change control. To this end, the lane change control unit 37 determines whether the whole vehicle 10 is within the adjacent lane, by referring to the position of the vehicle 10 measured as described above and the high-precision map or referring to two lane lines demarcating the adjacent lane and detected from an image. When the whole vehicle 10 is within the adjacent lane, the lane change control unit 37 determines that the vehicle 10 has started to travel completely inside the adjacent lane.

The determination unit 38 determines whether at least one of the relative position and the relative speed between the vehicle 10 and a vicinity vehicle traveling on the destination adjacent lane, which are detected by the vehicle detection unit 36, satisfies a predetermined interruption condition, while the lane change control unit 37 is executing lane change control.

For example, the determination unit 38 determines the distance between the vehicle 10 and a vicinity vehicle traveling behind the vehicle 10 on the adjacent lane, based on the relative position between the vicinity vehicle and the vehicle 10. When the distance between the vehicles falls below a predetermined distance threshold, the determination unit 38 determines that the interruption condition is satisfied. The determination unit 38 may predict the distance between the vicinity vehicle and the vehicle 10 until a predetermined time ahead, by applying prediction processing, such as a Kalman filter, to the changes in the relative position between the vicinity vehicle and the vehicle 10 in the most recent predetermined period. In the case where the predicted distance between the vicinity vehicle and the vehicle 10 at a certain time falls below the distance threshold, the determination unit 38 may determine that the interruption condition is satisfied. The interruption condition may be set as a combination of the distance and the relative speed between the vicinity vehicle and the vehicle 10. For example, the distance threshold may be set smaller as the relative speed between the vicinity vehicle and the vehicle 10 is greater, when the vicinity vehicle is faster than the vehicle 10. Further, in the case where the vicinity vehicle traveling behind the vehicle 10 on the adjacent lane is faster than the vehicle 10 and where the relative speed between the vicinity vehicle and the vehicle 10 is greater than a predetermined speed threshold, the determination unit 38 may determine that the interruption condition is satisfied, regardless of the distance between the vicinity vehicle and the vehicle 10. Further, the determination unit 38 may determine a predicted time until a collision between the vehicle 10 and the vicinity vehicle, based on the result of prediction of the distance between the vicinity vehicle and the vehicle 10. When the predicted time falls below a predetermined time threshold, the determination unit 38 may determine that the interruption condition is satisfied.

When multiple vicinity vehicles are traveling behind the vehicle 10 on the adjacent lane, the determination unit 38 only has to execute the above-described processing on the vicinity vehicle closest to the vehicle 10 to determine whether the interruption condition is satisfied.

During execution of lane change control, the distance between the vehicle 10 and a vicinity vehicle traveling ahead of the vehicle 10 may decrease rapidly, for example, because the vicinity vehicle suddenly decelerates. In view of this, the determination unit 38 determines whether the interruption condition is satisfied regarding a vicinity vehicle traveling ahead of the vehicle 10, in the same manner as described above. However, as for the condition related to the relative speed, the determination unit 38 determines that the interruption condition is satisfied, when the speed of the vicinity vehicle relative to the vehicle 10 is less than a predetermined speed threshold, unlike the condition for a vehicle behind. Further, the interruption condition for a vicinity vehicle preceding the vehicle 10 may be set separately from the interruption condition for a vicinity vehicle following the vehicle 10.

In the present embodiment, the determination unit 38 makes the interruption condition less strict when towing a towed vehicle 11 by the vehicle 10 is detected than when towing a towed vehicle 11 by the vehicle 10 is not detected. For example, in the case where the interruption condition is that the distance between the vehicle 10 and a vicinity vehicle falls below the distance threshold, as described above, the determination unit 38 makes the distance threshold higher when towing a towed vehicle 11 by the vehicle 10 is detected than when towing a towed vehicle 11 by the vehicle 10 is not detected. In the case where the interruption condition is that the speed of a vicinity vehicle relative to the vehicle 10 exceeds the speed threshold, the determination unit 38 makes the speed threshold lower when towing a towed vehicle 11 by the vehicle 10 is detected than when towing a towed vehicle 11 by the vehicle 10 is not detected. In the case where the interruption condition is that the predicted time until a collision between the vehicle 10 and a vicinity vehicle falls below the time threshold, the determination unit 38 makes the time threshold higher when towing a towed vehicle 11 by the vehicle 10 is detected than when towing a towed vehicle 11 by the vehicle 10 is not detected.

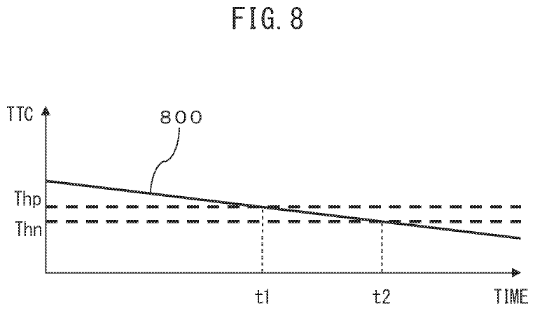

FIG. 8 illustrates the relationship between whether towing a towed vehicle 11 is detected and the time threshold, which is an example of the interruption condition. In FIG. 8, the abscissa represents time, and the ordinate represents a predicted time until a collision between the vehicle 10 and a vicinity vehicle (Time to Collision, TTC). A chart 800 represents time-varying changes in TTC. In this example, the vicinity vehicle is supposed to approach the vehicle 10, resulting in TTC decreasing with the passage of time.

As illustrated in FIG. 8, a time threshold Thp for the case where towing a towed vehicle 11 is detected is set greater than a time threshold Thn for the case where towing a towed vehicle 11 is not detected. This results in timing t1 when TTC falls below the time threshold Thp being earlier than timing t2 when TTC falls below the time threshold Thn. Thus, lane change control is interrupted earlier when towing a towed vehicle 11 is detected than when towing is not detected. In this way, the vehicle controller according to the present embodiment can interrupt lane change control at early timing in proportion to slowness of motion of the vehicle 10 caused by towing a towed vehicle 11. Thus the vehicle controller can appropriately set timing for interrupting lane change control so as to reduce the possibility of a collision between the vehicle 10 and a vicinity vehicle during towing a towed vehicle 11.

When determining that the interruption condition is satisfied, the determination unit 38 notifies the result of the determination to the interruption unit 39.

When receiving the result of determination that the interruption condition is satisfied from the determination unit 38, the interruption unit 39 notifies the lane change control unit 37 of an instruction to interrupt lane change control.

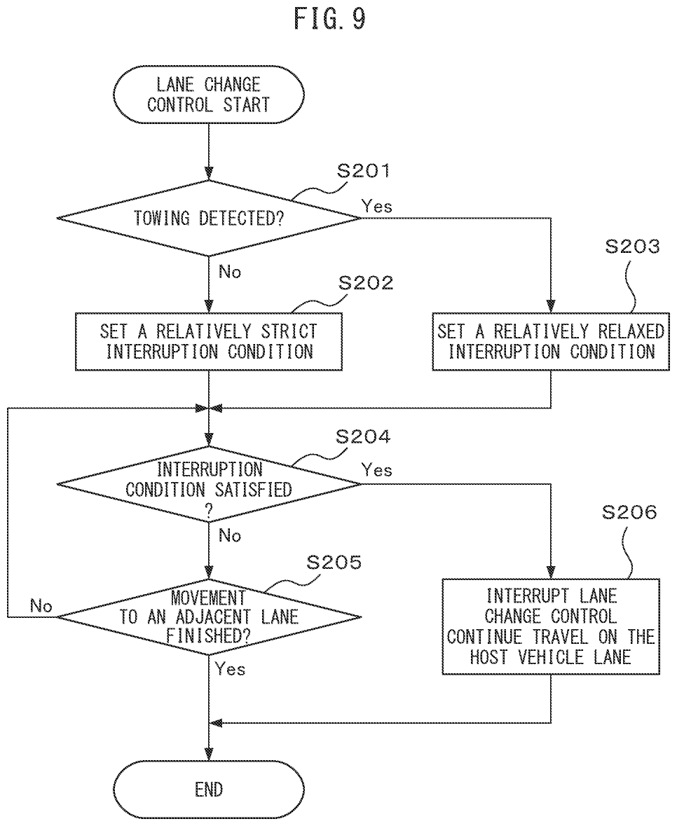

FIG. 9 is an operation flowchart of the vehicle control process according to the second embodiment. When the lane change determination unit 35 determines to apply lane change control, the processor 23 executes the vehicle control process related to lane change control in accordance with the operation flowchart described below.

The towing detection unit 31 of the processor 23 determines whether towing a towed vehicle 11 by the vehicle 10 is detected (step S201).

When towing a towed vehicle 11 is not detected (No in step S201), the determination unit 38 of the processor 23 sets a relatively strict interruption condition (step S202). When towing a towed vehicle 11 is detected (Yes in step S201), the determination unit 38 sets a relatively relaxed interruption condition (step S203).

The determination unit 38 of the processor 23 determines whether the interruption condition is satisfied, while the lane change control unit 37 of the processor 23 is executing lane change control on the vehicle 10 (step S204). When the interruption condition is not satisfied (No in step S204), the lane change control unit 37 determines whether movement of the vehicle 10 to a destination adjacent lane is finished (step S205). When movement of the vehicle 10 to the adjacent lane is finished (Yes in step S205), the processor 23 terminates the vehicle control process related to lane change control. When movement of the vehicle 10 to the adjacent lane is not finished (No in step S205), the processor 23 repeats the processing of step S204 and the subsequent steps.

When the interruption condition is satisfied in step S204 (Yes in step S204), the lane change control unit 37 interrupts lane change control and controls the vehicle 10 to continue travel on the host vehicle lane (step S206). Thereafter, the processor 23 terminates the vehicle control process related to lane change control.

As has been described above, the vehicle controller according to the second embodiment makes the interruption condition of lane change control less strict when towing a towed vehicle is detected than when towing a towed vehicle is not detected. Thus the vehicle controller can interrupt lane change control at early timing in proportion to slowness of motion of the host vehicle caused by towing, and therefore appropriately set timing for interrupting lane change control so as to reduce the possibility of a collision between the host vehicle and a vicinity vehicle during towing a towed vehicle.

According to a modified example, the interruption condition may be set depending on conditions around the vehicle 10, as in the modified example of the first embodiment. For example, the interruption condition for the case where the vicinity vehicle traveling on the destination adjacent lane is a large-size vehicle may be set separately from the interruption condition for the case where the vicinity vehicle is another type of vehicle. However, even in this case, the determination unit 38 makes the interruption condition less strict when towing a towed vehicle 11 by the vehicle 10 is detected than when towing a towed vehicle 11 by the vehicle 10 is not detected, regardless of the type of the vicinity vehicle. The determination unit 38 determines whether to interrupt lane change control, based on the interruption condition corresponding to the type of the vicinity vehicle traveling on the destination adjacent lane detected by the vehicle detection unit 36. When multiple vicinity vehicles traveling on the destination adjacent lane are detected, the determination unit 38 only has to use the interruption condition corresponding to the type of the vicinity vehicle closest to the vehicle 10.

Similarly, the interruption condition may be set individually, depending on the speed of the vehicle 10, a vicinity vehicle, or a vehicle behind the vehicle 10 at the time of execution of lane change control, the width of the host vehicle lane or the adjacent lane, the type of the adjacent lane (e.g., a passing lane or a travel lane), the time of day including the time of execution of lane change control, or weather. In this case, the determination unit 38 identifies the interruption condition to be used, by referring to the speed of the vehicle 10 measured by a vehicle speed sensor, the high-precision map, weather information, or the like, as in the modified example of the first embodiment. In addition, the interruption condition may be set individually for each event that has triggered a lane change (e.g., a lane change for passing a vehicle ahead or for moving to a lane leading toward a destination). In this case, the determination unit 38 receives trigger information indicating the event that has triggered a lane change from the lane change determination unit 35, and selects an interruption condition according to the trigger information. However, even in this case, the determination unit 38 makes the interruption condition less strict when towing a towed vehicle 11 by the vehicle 10 is detected than when towing a towed vehicle 11 by the vehicle 10 is not detected.

According to this modified example, the determination unit 38 can set the interruption condition appropriately, depending on conditions around the vehicle 10 as well as the presence or absence of a towed vehicle.

The processor 23 may be configured to execute both the vehicle control process according to the first embodiment or its modified examples and the vehicle control process according to the second embodiment or its modified examples. In other words, the processor 23 may include the units illustrated in FIG. 3 and the units illustrated in FIG. 7.

The computer program for achieving the functions of the processor 23 of the ECU 9 according to the embodiment or modified examples may be provided in a form recorded on a computer-readable portable storage medium, such as a semiconductor memory, a magnetic medium, or an optical medium.

As described above, those skilled in the art may make various modifications according to embodiments within the scope of the present disclosures.

What is claimed is:

1. A vehicle controller comprising:
a processor configured to:
detect that a host vehicle under autonomous driving control is towing a towed vehicle,
determine whether an involvement requirement for requesting a driver of the host vehicle to be involved in driving the host vehicle is satisfied, based on an exterior sensor signal generated by an exterior sensor configured to detect conditions around the host vehicle, an interior sensor signal generated by an interior sensor configured to detect conditions in an interior of the host vehicle, a vehicle motion signal generated by a motion sensor configured to detect motion of the host vehicle, or a position of the host vehicle,
give notification of the request for involvement in driving via a notification device provided in the interior of the host vehicle, when the involvement requirement is satisfied, and
make the involvement requirement less strict when towing the towed vehicle by the host vehicle is detected than when towing the towed vehicle by the host vehicle is not detected.

2. The vehicle controller according to claim 1, wherein the processor
measures a lateral distance between a lane line demarcating a lane being traveled by the host vehicle and the host vehicle, based on the exterior sensor signal, and determines that the involvement requirement is satisfied, when the lateral distance is not greater than a predetermined distance threshold; and
makes the distance threshold greater when towing the towed vehicle by the host vehicle is detected than when towing the towed vehicle by the host vehicle is not detected.

3. The vehicle controller according to claim 2, wherein the processor increases the distance threshold for a case where towing the towed vehicle by the host vehicle is detected, as weight or volume of the towed vehicle increases.

4. The vehicle controller according to claim 1, wherein the processor
determines that the involvement requirement is satisfied, when a speed of the host vehicle indicated by the vehicle motion signal is greater than a regulation speed of a road being traveled by the host vehicle by more than a predetermined speed threshold; and
sets the predetermined speed threshold to a lower value when towing the towed vehicle by the host vehicle is detected than when towing the towed vehicle by the host vehicle is not detected.

5. The vehicle controller according to claim 1, wherein the processor
determines that the involvement requirement is satisfied, when a regulation speed of a road being traveled by the host vehicle is less than a predetermined speed; and
sets the predetermined speed to a higher value when towing the towed vehicle by the host vehicle is detected than when towing the towed vehicle by the host vehicle is not detected.

6. The vehicle controller according to claim 1, wherein the processor
determines that the involvement requirement is satisfied, when a radius of curvature of a curve in a section being traveled by the host vehicle or extending to a predetermined distance away is less than a predetermined curvature radius threshold; and
sets the predetermined curvature radius threshold to a higher value when towing the towed vehicle by the host vehicle is detected than when towing the towed vehicle by the host vehicle is not detected.

7. The vehicle controller according to claim 1, wherein the processor
determines that the involvement requirement is satisfied, when a gradient of a road in a section being traveled by the host vehicle or extending to a predetermined distance away is not less than a predetermined gradient threshold; and
sets the predetermined gradient threshold to a lower value when towing the towed vehicle by the host vehicle is detected than when towing the towed vehicle by the host vehicle is not detected.

8. A vehicle controller comprising:
a processor configured to:
detect that a host vehicle under autonomous driving control is towing a towed vehicle,
detect a relative position and a relative speed between the host vehicle and another vehicle traveling on an adjacent lane adjacent to a host vehicle lane being traveled by the host vehicle;
execute lane change control of the host vehicle, when a predetermined condition is satisfied, so that the host vehicle makes a lane change from the host vehicle lane to the adjacent lane,
determine whether an interruption condition that is set based on at least one of the relative speed or a change in the relative position is satisfied during execution of the lane change control,
interrupt the lane change control when the interruption condition is satisfied, and
make the interruption condition less strict when towing the towed vehicle by the host vehicle is detected than when towing the towed vehicle by the host vehicle is not detected.

9. A method for vehicle control, comprising:
detecting that a host vehicle under autonomous driving control is towing a towed vehicle;
determining whether an involvement requirement for requesting a driver of the host vehicle to be involved in driving the host vehicle is satisfied, based on an exterior sensor signal generated by an exterior sensor configured to detect conditions around the host vehicle, an interior sensor signal generated by an interior sensor configured to detect conditions in an interior of the host vehicle, a vehicle motion signal generated by a motion sensor configured to detect motion of the host vehicle, or a position of the host vehicle;
giving notification of the request for involvement in driving via a notification device provided in the interior of the host vehicle, when the involvement requirement is satisfied; and
making the involvement requirement less strict when towing the towed vehicle by the host vehicle is detected than when towing the towed vehicle by the host vehicle is not detected.

10. A non-transitory recording medium that stores a computer program for vehicle control, the computer program causing a processor mounted on a host vehicle to execute a process comprising:
detecting that the host vehicle under autonomous driving control is towing a towed vehicle;
determining whether an involvement requirement for requesting a driver of the host vehicle to be involved in driving the host vehicle is satisfied, based on an exterior sensor signal generated by an exterior sensor configured to detect conditions around the host vehicle, an interior sensor signal generated by an interior sensor configured to detect conditions in an interior of the host vehicle, a vehicle motion signal generated by a motion sensor configured to detect motion of the host vehicle, or a position of the host vehicle;
giving notification of the request for involvement in driving via a notification device provided in the interior of the host vehicle, when the involvement requirement is satisfied; and
making the involvement requirement less strict when towing the towed vehicle by the host vehicle is detected than when towing the towed vehicle by the host vehicle is not detected.
